(19) United States
(12) Patent Application Publication
(10) Pub. No.: US 2026/0172403 A1
(43) Pub. Date: Jun. 18, 2026

(54) SYSTEM FOR SHARING INFORMATION AMONG MULTIPLE PRIVATE BLOCKCHAINS AND METHOD OF SHARING INFORMATION AMONG MULTIPLE PRIVATE BLOCKCHAINS USING THE SAME

(71) Applicant: Crosshub Inc., Jeonju-si (KR)

(72) Inventor: Jaeseol KIM, Namyangju-si (KR)

(73) Assignee: Crosshub Inc., Jeonju-si (KR)

(21) Appl. No.: 19/403,359

(22) Filed: Nov. 28, 2025

(30) Foreign Application Priority Data
Dec. 13, 2024 (KR) 10-2024-0186337
Apr. 17, 2025 (KR) 10-2025-0050150

(51) Int. Cl. H04L 9/40

(52) U.S. Cl. CPC H04L 63/0428

(57) ABSTRACT

A system for sharing information among multiple private blockchains and a method of sharing information among multiple private blockchains using the same are provided. A system for sharing information among multiple private blockchains according to various embodiments of the present disclosure includes multiple main networks operating independently of each other and an information sharing network connecting the multiple main networks, in which each of the multiple main networks is a private blockchain including multiple nodes, and the information sharing network connects nodes, each of which is any one of the multiple nodes included in a corresponding one of the multiple main networks.

### CROSS-REFERENCE TO RELATED APPLICATION

This application claims priority to and the benefit of Korean Patent Application No. 10-2025-0050150, filed on Apr. 17, 2025, and Korean Patent Application No. 10-2024-0186337, filed on Dec. 13, 2024, the disclosure of which is incorporated herein by reference in its entirety.

### BACKGROUND

### 1. Field of the Invention

Various embodiments of the present disclosure relate to a system for sharing information among multiple private blockchains and a method of sharing information among multiple private blockchains using the same.

### 2. Discussion of Related Art

Blockchains are a form of distributed ledger technology that allows data to be shared and verified among network participants without a central server. The blockchains store transaction histories or data records in blocks at fixed time intervals and link the stored transaction histories or data records in a chain structure, thereby making tampering extremely difficult. The blockchains ensure transparency, reliability, and integrity due to these characteristics, and thus are being utilized across various industries such as finance, distribution, logistics, and healthcare.

Blockchains are broadly divided into public and private blockchains based on their operating methods. Public blockchains are structured so that anyone may participate in the network, and representative examples of public blockchains include Bitcoin and Ethereum. On the other hand, private blockchains have restricted access authority, allowing only authorized users to participate in a network. Private blockchains are mainly used in environments such as enterprises and public institutions, where the security and management efficiency of internal information are prioritized.

Recently, local governments have been increasingly building and operating private blockchains tailored to their regional characteristics and administrative demands. For example, some local governments are operating their own blockchain systems to record handling details of administrative complaints from local residents on the blockchains or to transparently manage issuance and settlement records of local currencies. These private blockchains are designed for specific purposes at the local government level and restrict external access, enabling stable and efficient data processing.

However, the distributed operation of the private blockchains leads to the problem of disconnection in information sharing. As each local government operates an independent blockchain system, the exchange and integration of data between local governments is limited. This may lead to inefficiency due to information shortages, particularly in administrative tasks requiring regional collaboration, such as establishing interconnected welfare services, disaster response, and transportation policies. In addition, when the technical structures or data formats of blockchains operated by each local government differ, it is difficult to secure interoperability between systems, limiting the utilization of integrated data.

Therefore, the need for technological means to facilitate cooperation and collaboration between local governments by enabling information sharing between private blockchains is emerging. Technological approaches to addressing these problems are becoming increasingly important with the advancement of blockchain technology, and various solutions are being studied.

The above-described background art is a technology possessed or acquired by the inventors in the process of deriving the content of the present disclosure and may not necessarily be considered a publicly disclosed technology prior to the present application.

### SUMMARY OF THE INVENTION

An object of the present disclosure is to address the above-described problems of conventional private blockchains, and the present disclosure is directed to providing a system for sharing information among multiple private blockchains and a method of sharing information among multiple private blockchains using the same, which are capable of not only independently operating each private blockchain network and but also allowing interaction with other private blockchain networks when necessary by forming an information sharing network that connects multiple private blockchain networks and performing procedures such as information sharing, verification, and consensus among the multiple private blockchain networks based on the information sharing network.

Objects of the present disclosure are not limited to the above-mentioned objects. That is, other objects that are not mentioned may be obviously understood by those skilled in the art from the following description.

According to an aspect of the present invention, there is provided a system for sharing information among multiple private blockchains includes: multiple main networks operating independently of each other; and an information sharing network connecting the multiple main networks, in which each of the multiple main networks is a private blockchain including multiple nodes, and the information sharing network connects nodes, each of which is any one of the multiple nodes included in a corresponding one of the multiple main networks.

The multiple nodes may include: multiple first nodes corresponding to individual participants participating in the private blockchain; and a second node performing information sharing with another private blockchain, and the information sharing network may connect the second nodes included in the multiple main networks.

When a specific block is generated and distributedly stored in multiple nodes included in a specific main network among the multiple main networks, the specific block may be shared with the information sharing network through a second node of the specific main network, and the specific block shared through the information sharing network may be stored in the second nodes of the multiple main networks connected to the information sharing network.

When a new specific main network is added, the system for sharing information may connect a second node of the specific main network to second nodes already included in the information sharing network and synchronize the second node of the specific main network with the second nodes already included in the information sharing network.

The system for sharing information may share blocks stored in the second node of the specific main network with the second nodes already included in the information sharing network through the information sharing network and selectively share only blocks that have been verified among the blocks stored in the second node of the specific main network.

The system for sharing information may verify the blocks stored in the second node of the specific main network by comparing metadata of the blocks stored in the second node of the specific main network with metadata of the blocks stored in each of multiple first nodes of the specific main network through the multiple first nodes of the specific main network.

The system for sharing information may generate a third node, which is a verification node, within the specific main network, synchronize multiple first nodes of the specific main network with the third node of the specific main network, and verify the blocks stored in the second node of the specific main network through the synchronized third node.

When a first main network receives an information verification request from a second main network through the information sharing network, the system for sharing information may generate a verification result corresponding to the information verification request and transmit the generated verification result through the information sharing network, and the main networks excluding the first main network and the second main network among the multiple main networks may generate a consensus result on the verification result shared through the information sharing network and transmit the generated consensus result to the second main network through the information sharing network.

The system for sharing information may generate a zero-knowledge proof (ZK proof) as the verification result by performing verification on the information verification request through the first main network.

According to another aspect of the present invention, there is provided a method of sharing information among multiple private blockchains, performed through an information sharing system including multiple main networks operating independently of each other and an information sharing network connecting the multiple main networks includes: generating a verification result in response to an information verification request, which is acquired from a second main network through the information sharing network, through a first main network among the multiple main networks; transmitting the generated verification result through the information sharing network; generating a consensus result on a verification result shared through the information sharing network by the main networks excluding the first main network and the second main network among the multiple main networks; and transmitting the generated consensus result to the second main network through the information sharing network.

Other specific details of the present disclosure are included in the detailed description and drawings.

### BRIEF DESCRIPTION OF DRAWINGS

The following drawings attached to this specification illustrate preferred embodiments of the present disclosure, and serve to further understand the technical idea of the present disclosure together with the detailed description of the present disclosure, so the present disclosure should not be interpreted as being limited to matters described in such drawings:

FIGS. 1 and 2 are diagrams illustrating a system for sharing information among multiple private blockchains according to an embodiment of the present disclosure;

FIG. 3 is a flowchart illustrating a method of sharing information among multiple private blockchains using a system for sharing information according to another embodiment of the present disclosure; and

FIG. 4 is a diagram illustrating a hardware configuration of a computing device applicable to various embodiments of the present disclosure.

### DETAILED DESCRIPTION OF EXEMPLARY EMBODIMENTS

Various advantages and features of the present disclosure and methods accomplishing them will become apparent from the following description of embodiments with reference to the accompanying drawings. However, the present disclosure is not limited to embodiments to be described below, but may be implemented in various different forms, these embodiments will be provided only in order to make the present disclosure complete and allow those skilled in the art to completely recognize the scope of the present disclosure, and the present disclosure will be defined by the scope of the claims.

Terms used in the present specification are for explaining embodiments rather than limiting the present disclosure. Unless otherwise stated, a singular form includes a plural form in the present specification. Throughout this specification, the term “comprise” and/or “comprising” will be understood to imply the inclusion of stated constituents but not the exclusion of any other constituents.

Like reference numerals refer to like components throughout the specification and “and/or” includes each of the components mentioned and includes all combinations thereof. Although “first,” “second,” and the like are used to describe various components, it goes without saying that these components are not limited by these terms. These terms are used only to distinguish one component from other components. Therefore, it goes without saying that a first component mentioned below may be a second component within the technical scope of the present disclosure.

The term “unit” or “module” used in the specification refers to a software component or a hardware component such as an FPGA or ASIC, and the “unit” or “module” performs certain roles. However, the term “unit” or “module” is not intended to be limited to software or hardware. A “unit” or “module” may be configured to be stored in a storage medium that can be addressed or may be configured to regenerate one or more processors. Accordingly, for example, a “unit” or “module” includes components such as software components, object-oriented software components, class components, and task components, processors, functions, attributes, procedures, subroutines, segments of a program code, drivers, firmware, a microcode, a circuit, data, a database, data structures, tables, arrays, and variables. Functions provided in components, “units,” or “modules” may be combined into fewer components, “units,” or “modules” or further separated into additional components, “units,” or “modules.”

Spatially relative terms “below,” “beneath,” “lower,” “above,” “upper,” and the like may be used to easily describe the correlation between one component and other components as illustrated in the drawings. The spatially relative terms should be understood as terms including different directions of components during use or operation in addition to the directions illustrated in the drawings. For example, when components illustrated in the drawings are turned over, a component described as “below” or “beneath” another component may be placed “above” the other component. Therefore, the illustrative term “below” can include both downward and upward directions. The components can also be aligned in different directions, and therefore the spatially relative terms can be interpreted according to the alignment.

Unless the context indicates otherwise, the expressions “1^{st},” “2^{nd},” “first,” “second,” etc., used in this specification are used to distinguish one object from another when referring to multiple similar objects, and do not limit the order or importance among the objects.

As described herein, the expressions “A, B, and C,” “A, B, or C,” “A, B, and/or C,” “at least one of A, B, and C,” “at least one of A, B, or C,” “at least one of A, B, and/or C,” “at least one selected from A, B, and C,” “at least one selected from A, B, or C,” “at least one selected from A, B, and/or C,” etc., may refer to each listed item or all possible combinations of the listed items. For example, “at least one selected from A and B” may refer to (1) A, (2) at least one of A, (3) B, (4) at least one of B, (5) at least one of A and at least one of B, (6) B and at least one of A, (7) A and at least one of B, or (8) both A and B. As used herein, the expression “based on” is used to describe one or more factors that influence a decision, determination, or action described in a phrase or a sentence containing the corresponding expression, and this expression does not exclude additional factors that influence the corresponding decision, determination, or action.

As used herein, the expression that a component (e.g., a first component) is “connected” or “coupled” to another component (e.g., a second component) may mean not only that the component is directly connected or coupled to the other component, but also that the component is connected or coupled via a new other component (e.g., a third component).

The expression “configured to” used in this specification may have various meanings, such as “set to,” “having the ability to,” “modified to,” “made to,” and “capable of” depending on the context. The expression is not limited to the meaning of “specifically so designed in hardware.” For example, a processor configured to perform a specific operation may be a general-purpose processor capable of performing the specific operation by executing software.

Unless defined otherwise, all terms (including technical and scientific terms) used in the present specification have the same meanings commonly understood by those skilled in the art to which the present disclosure pertains. In addition, the terms defined in commonly used dictionaries are not ideally or excessively interpreted unless explicitly defined otherwise.

In this specification, a computer is any kind of hardware device including at least one processor and can be understood as including a software configuration which is operated in the corresponding hardware device according to the embodiment. For example, the meaning of “computer” may be understood to include all of smartphones, tablet PCs, desktops, notebooks, and user clients and applications running on each device, but is not limited thereto.

Hereinafter, embodiments of the present disclosure will be described in detail with reference to the accompanying drawings.

Each step described in this specification is described as being performed by a computer, but subjects of each step are not limited thereto, and according to embodiments, at least some steps can also be performed on different devices.

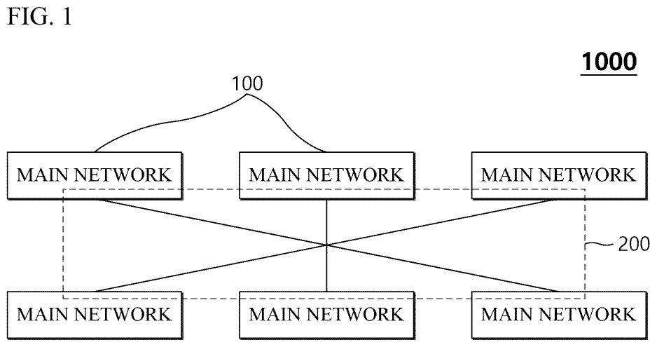

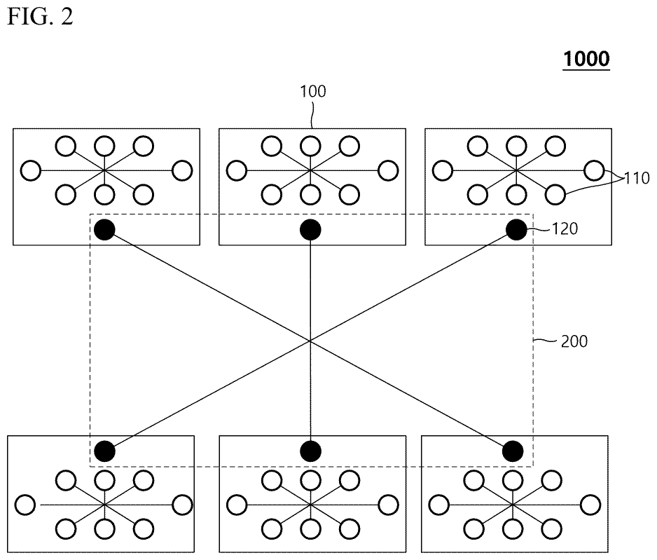

FIGS. 1 and 2 are diagrams illustrating a system for sharing information among multiple private blockchains according to an embodiment of the present disclosure.

Referring to FIGS. 1 and 2, a system 1000 for sharing information according to various embodiments of the present disclosure may include multiple main networks 100 and an information sharing network 200.

Here, the system 1000 for sharing information illustrated in FIG. 1 is according to an embodiment, and components of the system 1000 for sharing information are not limited to the embodiment illustrated in FIG. 1, and some components may be added, changed, or omitted as necessary.

First, multiple main networks 100 may be networks that operate independently of each other.

For example, each of the multiple main networks 100 may be a private blockchain including multiple nodes (e.g., 110, 120).

Unlike a public blockchain, the private blockchain may be a closed blockchain network with restricted access. That is, the main network 100 may be a blockchain network designed so that only pre-authorized participants may participate in the network and may be a blockchain network designed such that only nodes with certain permissions may perform actions such as block generation, verification, storage, and inquiry.

In various embodiments, the multiple main networks 100 may include multiple first nodes 110 corresponding to individual participants participating in each private blockchain.

For example, the multiple main networks 100 may be private blockchains (e.g., Daegu Network, Busan Network, Seoul Network, etc.) operated by local governments. The multiple first nodes 110 included in a corresponding main network 100 may be servers operated by organizations, companies, etc., (e.g., district offices, city halls, public institutions, consignment operation companies, cooperative private companies, etc.) under each local government, but are not limited thereto.

The multiple first nodes 110 included in each of the multiple main networks 100 may be classified into central nodes (e.g., nodes operated by a city hall or district office) that are responsible for block generation and overall network management, and participating nodes that generate transactions and record data on the blockchain.

In various embodiments, each of the multiple main networks 100 may include a second node 120 that performs information sharing with other private blockchains. Here, the second node may be a server separately provided and operated for information sharing with other blockchains but is not limited thereto.

Next, the information sharing network 200 may be a network that connects the multiple main networks 100 by connecting nodes, each of which is any one of the multiple nodes included in each of the multiple main networks 100.

For example, the information sharing network 200 may connect second nodes 120 included in each of the multiple main networks 100 but is not limited thereto.

In various embodiments, when a specific block is generated and distributedly stored in multiple nodes (e.g., the first node 110 and the second node 120) included in a specific main network 100 among the multiple main networks 100, the specific block may be shared with the information sharing network 200 through the second node 120 of the specific main network 100, and the specific block shared through the information sharing network 200 may be stored in the second nodes 120 of each of the multiple main networks 100 connected to the information sharing network 200.

In various embodiments, when the specific main network 100 is newly added, the system 1000 for sharing information may connect the second node 120 of the specific main network 100 to the second nodes 120 already included in the information sharing network 200, and synchronize the second nodes 120 of the specific main network 100 to the second nodes 120 already included in the information sharing network 200.

In this case, the system 1000 for sharing information may share the blocks stored in the second node 120 of the specific main network 100 with the second nodes 120 already included in the information sharing network 200 through the information sharing network 200, but may selectively share only blocks that have been verified among the blocks stored in the second node 120 of the specific main network 100.

For example, the system 1000 for sharing information may verify the blocks stored in the second node 120 of the specific main network 100 by comparing metadata of blocks stored in the second node 120 of the specific main network 100 with metadata of blocks stored in each of the multiple first nodes 110 of the specific main network 100 through the multiple first nodes 110 of the specific main network 100.

For example, the metadata (hash value, transaction, previous block information, etc.) of the blocks stored in the second node 120 of the specific main network 100 may be transmitted to the multiple first nodes 110 of the specific main network 100 to perform verification (e.g., hash chain verification, transaction validity verification, signature verification, etc.) on the blocks stored in the second node 120 through the multiple first nodes 110, and a block for which the same verification result is derived from a certain number or more of the first nodes 110 among the multiple first nodes 110 may be determined as a reliable block.

As another example, the system 1000 for sharing information may generate a third node, which is a verification node, within the specific main network 100, synchronize the multiple first nodes 110 of the specific main network 100 with the third node of the specific main network 100, and verify the blocks stored in the second node of the specific main network 100 through the synchronized third node. For example, the metadata of the blocks stored in the second node 120 of the specific main network 100 may be transmitted to the third node to perform the verification of the blocks stored in the second node 120 through the third node. When the blocks stored in the second node 120 are stored through the multiple first nodes 110 included in the specific main network 100, problems such as increasing the computational amount of the multiple first nodes 110 and reducing the speed may occur. Therefore, by using a separate node for verification, the burden on the first nodes 110 may be minimized.

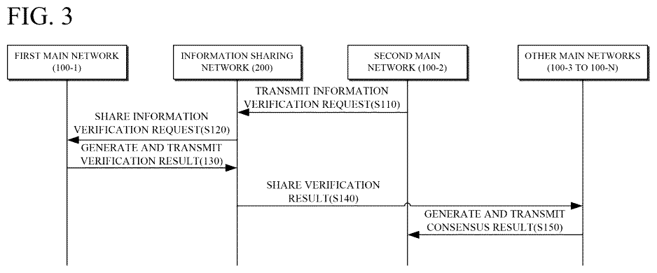

In various embodiments, the system 1000 for sharing information may perform the information sharing between the multiple main networks 100 through the information sharing network 200. Hereinafter, a method of sharing information among multiple private blockchains using an information sharing system will be described with reference to FIG. 3.

FIG. 3 is a flowchart of a method of sharing information among multiple private blockchains using an information sharing system according to another embodiment of the present disclosure.

Referring to FIG. 3, in operation S110, an information verification request is generated through a second main network 100-2, and the information verification request generated through the second main network 100-2 is shared with the information sharing network 200 through the second node 120 of the second main network 100-2.

For example, when a specific customer of a second bank participating in a second main network 100-2 operating in a second region needs to be verified as being qualified for a specific loan from a first bank participating in a first main network 100-1 operating in a second region, an information verification request may be generated through the first node 110 corresponding to the second bank in the second main network 100-2 requesting verification of whether the specific customer is qualified for the loan.

Furthermore, the information verification request generated through the first node 110 corresponding to the second bank in the second main network 100-2 may be shared with the information sharing network 200 through the second node 120 of the second main network 100-2.

In operation S120, the information verification request shared with the information sharing network 200 through the second node 120 of the second main network 100-2 is shared with the first main network 100-1, which is a verifier capable of verifying the specific customer, through the information sharing network 200.

In operation S130, the verification result is generated through the first main network 100-1 in response to the information verification request shared with the first main network 100-1 through the information sharing network 200, and the verification result generated through the first main network 100-1 is shared with the information sharing network 200 through the second node 120 of the first main network 100-1.

The first bank participating in the first main network 100-1 may, in response to the information verification request acquired from the second bank participating in the second main network 100-2, generate the verification result including the results of determining whether the specific customer is eligible for the loan based on internal information such as the customer's credit rating and debt history, and transmit the verification result to the information sharing network 200 again.

In various embodiments, the first main network 100-1 may generate a zero-knowledge proof (ZK Proof) as the verification result by performing the verification on the information verification request but is not limited thereto.

The ZK Proof is cryptographic technique that allows the truth of a specific piece of information to be proven without directly revealing the information and is a method that enables a verifier to confirm that certain secret information is valid without knowing the content of the information from a prover.

In operation S140, the verification result transmitted to the information sharing network 200 through the first main network 100-1 is shared with other main networks 100-3 to 100-N, in which the first main network 100-1 and the second main network 100-2 are not included, among the multiple main networks 100 included in the information sharing network 200.

In operation S150, the verification result shared with the other main networks 100-3 to 100-N is agreed upon by the other main networks 100-3 to 100-N, thereby generating a consensus result, and the consensus result is transmitted to the second main network 100-2 through the information sharing network 200.

Through the above-described process, the first node 110 corresponding to the first bank of the second main network 100-1 may receive the verification result generated through the first main network 100-1 and the consensus result generated from other main networks 100-3 to 100-N through the information sharing network 200 and may perform final information verification based on the received verification result.

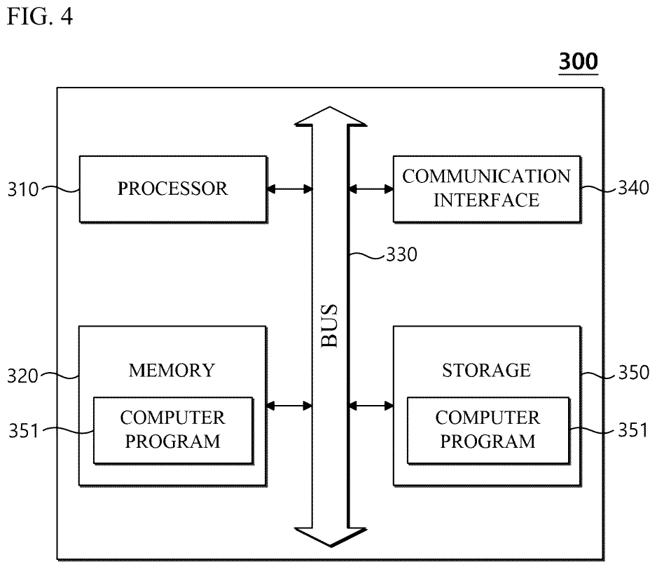

The above-described method of sharing information among multiple private blockchains using a system for sharing information was given with reference to the flowchart illustrated in the drawings. For a simple description, the method of sharing information among multiple private blockchains using a system for sharing information has been described by showing a series of blocks, but the present disclosure is not limited to the order of the blocks, and some blocks may be performed in an order different from that shown and performed in the present specification, or may be performed concurrently. In addition, new blocks not described in the present specification and drawings may be added, or some blocks may be omitted or changed. Hereinafter, the hardware configuration of the server (computing device) operating the first node 110 and the second node 120 included in the main network 100 will be described with reference to FIG. 4.

FIG. 4 is a diagram illustrating a hardware configuration of a computing device applicable to various embodiments of the present disclosure.

Referring to FIG. 4, a computing device 300 according to another embodiment of the present disclosure may operate nodes included in each of the plurality of private blockchains included in the system for sharing information. To this end, the computing device 300 may include one or more processors 310, a memory 320 into which a computer program 351 executed by the processor 310 is loaded, a bus 330, a communication interface 340, and a storage 350 for storing the computer program 351. Here, only the components related to the embodiment of the present disclosure are illustrated in FIG. 2. Accordingly, those skilled in the art to which the present disclosure pertains may understand that general-purpose components other than those illustrated in FIG. 2 may be further included.

The processor 310 controls an overall operation of each component of the computing device 300. The processor 310 may be configured to include a central processing unit (CPU), a micro processor unit (MPU), a micro controller unit (MCU), a graphics processing unit (GPU), or any type of processor well known in the art of the present disclosure.

In addition, the processor 310 may perform an operation on at least one application or program for executing the method according to the embodiments of the present disclosure, and the computing device 300 may include one or more processors.

According to various embodiments, the processor 310 may further include a random access memory (RAM) (not illustrated) and a read-only memory (ROM) for temporarily and/or permanently storing signals (or data) processed in the processor 310. In addition, the processor 310 may be implemented in the form of a system-on-chip (SoC) including at least one of a GPU, a RAM, and a ROM.

The memory 320 stores various types of data, commands, and/or information. The memory 320 may load the computer program 351 from the storage 350 to execute methods/operations according to various embodiments of the present disclosure. When the computer program 351 is loaded into the memory 320, the processor 310 may perform the method/operation by executing one or more instructions constituting the computer program 351. The memory 320 may be implemented as a volatile memory such as a RAM, but the technical scope of the present disclosure is not limited thereto.

The bus 330 provides a communication function between the components of the computing device 300. The bus 330 may be implemented as various types of buses, such as an address bus, a data bus, and a control bus.

The communication interface 340 supports wired/wireless Internet communication of the computing device 300. In addition, the communication interface 340 may support various communication methods other than the Internet communication. To this end, the communication interface 340 may be configured to include a communication module well known in the art of the present disclosure. In some embodiments, the communication interface 340 may be omitted.

The storage 350 may non-temporarily store the computer program 351. When performing block generation, verification, storage, and inquiry processes within the private blockchain network through the computing device 300, the storage 350 may store various pieces of information necessary to provide the block generation, verification, storage, and inquiry processes within the private blockchain network.

The storage 350 may be configured to include a nonvolatile memory, such as a ROM, an erasable programmable ROM (EPROM), an electrically erasable programmable ROM (EEPROM), and a flash memory, a hard disk, a removable disk, or any well-known computer-readable recording medium in the art to which the present disclosure belongs.

The computer program 351 may include one or more instructions to cause the processor 310 to perform methods/operations according to various embodiments of the present disclosure when loaded into the memory 320. That is, the processor 310 may perform the method/operation according to various embodiments of the present disclosure by executing the one or more instructions.

The above-described method may be provided as a computer program stored in a computer-readable recording medium for execution on a computer. The medium may continuously store a computer-executable program or may be a temporary storage for execution or download. In addition, the medium may be various types of recording means or storage means in the form of single hardware or in the form of several pieces of hardware combined and may not be limited to a medium directly connected to any computer system, and may distributedly exist on a network. Examples of the medium may include those configured to store and execute program commands, including magnetic media such as a hard disk, a floppy disk, and a magnetic tape, optical recording media such as a compact disc read only memory (CD-ROM) and a digital versatile disk (DVD), a magneto-optical medium such as a floptical disk, a ROM, a RAM, a flash memory, and the like. In addition, examples of other media include recording media or storage media managed by app stores that distribute applications, sites that supply or distribute various other software, and servers.

The methods, operations, or techniques of the present disclosure may be implemented by various means. For example, such techniques may be implemented in hardware, firmware, software, or a combination thereof. It will be understood by those skilled in the art that the various illustrative logical blocks, modules, circuits, and algorithm steps described in conjunction with the present disclosure may be implemented in electronic hardware, computer software, or combinations of both. To clearly illustrate this interchangeability of hardware and software, various exemplary components, blocks, modules, circuits, and steps have been generally described above in terms of their functionality. Whether such functions are implemented as hardware or as software depends on the design requirements imposed on the particular application and the overall system. Those skilled in the art may implement the described functions in various ways for each particular application, however, such implementations should not be construed as departing from the scope of the present disclosure.

In a hardware implementation, the processing units used to perform the techniques may be implemented within one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computers, or combinations thereof.

Accordingly, various illustrative logical blocks, modules, and circuits described in conjunction with the present disclosure may be implemented or performed with a general-purpose processor, a DSP, an ASIC, an FPGA or other programmable logic devices, discrete gate or transistor logic, discrete hardware components, or any combination of components designed to perform the functions described herein. The general-purpose processor may be a microprocessor; alternatively, the processor may be any conventional processor, controller, microcontroller, or state machine. The processor may also be implemented as a combination of computing devices, for example, a DSP and a microprocessor, multiple microprocessors, one or more microprocessors in conjunction with a DSP core, or any other configuration of combinations.

In firmware and/or software implementation, the techniques may be implemented as instructions stored on computer-readable media such as a RAM, a ROM, a non-volatile RAM (NVRAM), a programmable ROM (PROM), an EPROM, an EEPROM, a flash memory, a CD, and a magnetic or optical data storage device. The instructions may be executable by one or more processors and may allow the processor(s) to perform certain aspects of the functionality described in this disclosure.

When implemented in software, the techniques may be stored on a computer-readable medium as one or more instructions or code or transmitted over the computer-readable media. The computer-readable media include both computer storage media and communication media including any medium that facilitates transmission of a computer program from one location to another. The storage media may be any available media that may be accessed by a computer. As a non-limiting example, such computer-readable media may include a RAM, a ROM, an EEPROM, a CD-ROM or another optical disk storage, magnetic disk storage or other magnetic storage devices, or desired program codes in the form of instructions or data structures, and any other media that may be used for transporting or storing desired program codes in the form of instructions or data structures and may be accessed by a computer. In addition, any access is properly called a computer-readable medium.

For example, when software is transmitted from a website, server, or other remote source using a coaxial cable, fiber optic cable, twisted pair, digital subscriber line (DSL), or wireless technologies such as infrared, radio, and microwave, the coaxial cable, fiber optic cable, twisted pair, digital subscriber line, or wireless technologies such as infrared, radio, and microwave are included within the definition of a medium. The disk and disc used herein include a CD, a laser disc, an optical disc, a DVD, a floppy disk, and a Blu-ray disc, in which disks typically reproduce data magnetically, while discs reproduce data optically using a laser. The above combinations are also to be included within the scope of computer-readable media.

A software module may reside in a RAM memory, a flash memory, a ROM memory, an EPROM memory, an EEPROM memory, a register, a hard disk, a removable disk, a CD-ROM, or any other form of storage medium known in the art. An exemplary storage medium may be coupled to a processor such that the processor may read information from, or write information to, the storage medium. Alternatively, the storage medium may be integrated into the processor. The processor and the storage medium may reside within an ASIC. The ASIC may exist in a user terminal. Alternatively, the processor and the storage medium may exist as separate components in the user terminal.

Although the above-described embodiments have been presented as utilizing aspects of the subject matter disclosed herein in one or more standalone computer systems, the present disclosure is not limited thereto and may be implemented in conjunction with any computing environment, such as a network or a distributed computing environment. Furthermore, aspects of the subject matter in the present disclosure may be implemented in multiple processing chips or devices, and the storage may be similarly affected across multiple devices. These devices may include PCs, network servers, and portable devices.

According to various embodiments of the present disclosure, by forming the information sharing network that connects the multiple private blockchain networks and performing the procedures such as information sharing, verification, and consensus among the multiple private blockchain networks based on the information sharing network, it is possible not only to independently operate each private blockchain network but also to allow the interaction with other private blockchain networks when necessary.

The effects of the present disclosure are not limited to the above-described effects, and other effects that are not mentioned may be obviously understood by those skilled in the art from the following description.

Although the present disclosure has been described in connection with some embodiments herein, various modifications and changes may be made without departing from the scope of the present disclosure as understood by those skilled in the art to which the present disclosure pertains. In addition, such modifications and changes should be considered to fall within the scope of the claims appended to this specification.

What is claimed is:

1. A system for sharing information among multiple private blockchains, comprising:
multiple main networks operating independently of each other; and
an information sharing network connecting the multiple main networks,
wherein each of the multiple main networks is a private blockchain including multiple nodes, and
the information sharing network connects nodes, each of which is any one of the multiple nodes included in a corresponding one of the multiple main networks.

2. The system of claim 1, wherein the multiple nodes include:
multiple first nodes corresponding to individual participants participating in the private blockchain; and
a second node performing information sharing with another private blockchain, and
the information sharing network connects the second nodes included in the multiple main networks.

3. The system of claim 2, wherein, when a specific block is generated and distributedly stored in multiple nodes included in a specific main network among the multiple main networks, the specific block is shared with the information sharing network through a second node of the specific main network, and
the specific block shared through the information sharing network is stored in the second nodes of the multiple main networks connected to the information sharing network.

4. The system of claim 1, wherein, when a new specific main network is added, the system for sharing information connects a second node of the specific main network to second nodes already included in the information sharing network, and
synchronizes the second node of the specific main network with the second nodes already included in the information sharing network.

5. The system of claim 4, wherein the system for sharing information shares blocks stored in the second node of the specific main network with the second nodes already included in the information sharing network through the information sharing network and selectively shares only blocks that have been verified among the blocks stored in the second node of the specific main network.

6. The system of claim 5, wherein the system for sharing information verifies the blocks stored in the second node of the specific main network by comparing metadata of the blocks stored in the second node of the specific main network with metadata of the blocks stored in each of multiple first nodes of the specific main network through the multiple first nodes of the specific main network.

7. The system of claim 5, wherein the system for sharing information generates a third node, which is a verification node, within the specific main network, synchronizes multiple first nodes of the specific main network with the third node of the specific main network, and
verifies the blocks stored in the second node of the specific main network through the synchronized third node.

8. The system of claim 1, wherein, when a first main network receives an information verification request from a second main network through the information sharing network, the system for sharing information generates a verification result corresponding to the information verification request and transmits the generated verification result through the information sharing network, and
the main networks excluding the first main network and the second main network among the multiple main networks generate a consensus result on the verification result shared through the information sharing network and transmit the generated consensus result to the second main network through the information sharing network.

9. The system of claim 8, wherein the system for sharing information generates a zero-knowledge proof (ZK proof) as the verification result by performing verification on the information verification request through the first main network.

10. A method of sharing information among multiple private blockchains, performed through an information sharing system including multiple main networks operating independently of each other and an information sharing network connecting the multiple main networks, the method comprising:
generating a verification result in response to an information verification request, which is acquired from a second main network through the information sharing network, through a first main network among the multiple main networks;
transmitting the generated verification result through the information sharing network;
generating a consensus result on a verification result shared through the information sharing network by the main networks excluding the first main network and the second main network among the multiple main networks; and
transmitting the generated consensus result to the second main network through the information sharing network.
